(19) United States
(12) Patent Application Publication
(10) Pub. No.: US 2011/0120244 A1
(43) Pub. Date: May 26, 2011

(54) TWO-SHAFT SHIFT GEARBOX OF A MOTOR VEHICLE

(75) Inventors: Axel GEIBERGER, Mainz (DE); Markus ROCKENBACH, Schweppenhausen (DE); Thomas HOFMANN, Florsheim (DE)

(73) Assignee: GM GLOBAL TECHNOLOGY OPERATIONS, INC., Detroit, MI (US)

(21) Appl. No.: 12/949,714

(22) Filed: Nov. 18, 2010

(30) Foreign Application Priority Data
Nov. 19, 2009 (DE) 102009053913.1

(51) Int. Cl. F16H 3/38

(52) U.S. Cl. 74/339

(57) ABSTRACT

A two-shaft shift gearbox is provided for a motor vehicle. The two-shaft shift gearbox has a drive shaft and an output shaft. Driving gearwheels are arranged on the drive shaft and output gearwheels are arranged on the output shaft. Switching elements bring the driving gearwheels in pairs in engagement with output gearwheels via gear synchronizers. Here, the driving gearwheel of the lowest gear with the smallest ring gear diameter is arranged on a first end section and the driving gearwheel of the highest gear with the largest ring gear diameter is arranged on a second end section of the drive shaft lying opposite the first end section.

### CROSS-REFERENCE TO RELATED APPLICATION

This application claims priority to German Patent Application No. 102009053913.1, filed Nov. 19, 2009, which is incorporated herein by reference in its entirety.

### TECHNICAL FIELD

The technical field relates to a two-shaft shift gearbox of a motor vehicle. The two-shaft shift gearbox has a drive shaft and an output shaft. Driving gearwheels are arranged on the drive shaft, and output gearwheels are arranged on the output shaft. Switching elements bring the driving gearwheels in pairs into engagement with output gearwheels via gear synchronizers.

### BACKGROUND

A two-shaft shift gearbox for a motor vehicle is known from the publication U.S. Pat. No. 5,392,665, in which the drive shaft in a one-sided gear synchronizer can be coupled with a further hollow shaft arranged on the drive shaft, and the output shaft additionally has a further hollow shaft with which the output shaft can be coupled via double gear synchronizers. By the arrangement of the hollow shafts, it is possible in the known prior art to manage with two double-sided gear synchronizers in order to shift six gears individually, with only four pairs of gearwheels being provided for the forward gears. This is made possible by the hollow shafts arranged on the output shaft and on the drive shaft.

This six-speed gearbox has the disadvantage that practically four shafts are to be produced, namely a drive shaft, an output shaft and in addition two hollow shafts which are arranged on the drive shaft or respectively on the output shaft. A further disadvantage is that in total four gear synchronizers are necessary, namely a first one-sided gear synchronizer, in order to connect the hollow shaft on the drive shaft with the drive shaft, and a second one-sided gear synchronizer, in order to be able to connect the output pinion of the reverse gear on the output shaft. Finally, a third double-sided gear synchronizer is required, in order on the one hand to optionally connect two driving gearwheels with output gearwheels on the hollow shaft of the output shaft, and on the other hand to connect the hollow shaft on the output shaft with the output shaft or respectively with the hollow shaft of the drive shaft.

In total, consequently, four gear synchronizers are required for the known six-speed gearbox. Therefore, the known gearbox entails the disadvantage that it is technically complicated and requires a complex force flow for the realization of six forward gears by means of four pairs of gearwheels, plus one gearwheel pair with a reversing gearwheel for the reverse gear.

In view of the foregoing, it is at least object to provide an improved six-speed gearbox which can also be produced without great effort as a five-speed gearbox with a saving of materials, gearwheel pairs and gear synchronizers for the sixth gear in a favorably priced manner. In addition, other objects, desirable features and characteristics will become apparent from the subsequent summary and detailed description, and the appended claims, taken in conjunction with the accompanying drawings and this background.

### SUMMARY

A two-shaft shift gearbox is provided for a motor vehicle. The two-shaft shift gearbox has a drive shaft and an output shaft. Driving gearwheels are arranged on the drive shaft and output gearwheels are arranged on the output shaft. Switching elements bring the driving gearwheels in pairs into engagement with output gearwheels via gear synchronizers. Here, the driving gearwheel of the lowest gear with the smallest ring gear diameter is arranged on a first end section, and the driving gearwheel of the highest gear with the largest ring gear diameter is arranged on a second end section of the drive shaft lying opposite the first end section. Thereby, the driving gearwheel of the highest gear is arranged on the drive shaft in a region which is furthest away from the engine coupling.

This has the advantage that at any time the six-speed gearbox and the drive shaft and also the output shaft can be shortened, in order to use the same two-shaft shift gearbox for a six-speed gearbox, a five-speed gearbox, a four-speed gearbox or a three-speed gearbox, for which merely either the gearwheel combinations with the associated gear synchronizers can be omitted or in addition also the drive shaft and the output shaft can be shortened, without altering the other components.

In an embodiment, a rotation direction reversing gearwheel is arranged on an auxiliary axis in the region of the first end section of the drive shaft, wherein the rotation direction reversing gearwheel at the same time meshes with a driving gearwheel and an output gearwheel for a reverse gear. For this, the driving gearwheel is arranged on the drive shaft between the engine coupling and the driving gearwheel for the first gear, therefore the driving gearwheel for the reverse gear is closest to the engine coupling.

In addition, provision is made that on the second end section on one of the two shafts of the two-shaft shift gearbox, a gear synchronizer acting on one side is arranged for a sixth gear. As the highest gear is arranged furthest away from the engine coupling on the second end section, advantageously the gear synchronizer, acting on one side, can either be arranged on the drive shaft in the second end section or on the output shaft. The torque to be transmitted for the sixth gear on the drive shaft is, however, distinctly greater than the torque which becomes effective on the output shaft owing to the transmission ratio, so that the gear synchronizer, acting on one side, on the output shaft has to transfer a smaller torque and hence also can be realized with smaller diameters. Therefore, the arrangement of the gear synchronizer is preferred that, acts on one side, on the output shaft.

As the first gear and the reverse gear on the drive shaft are arranged one behind the other, viewed from the engine coupling, it is preferred to use a gear synchronizer acting on both sides between the gearwheel pair of the first gear and the three gearwheels for the reverse gear. As the gear synchronizers require a minimum diameter for the coupling of ring gears, it is advantageous here to arrange the double-acting gear synchronizer between the larger output gearwheels of the first gear and of the reverse gear.

In a further embodiment, the driving gearwheels are arranged in succession with increasing gear number in a rising sequence from the first end section to the second end section with increasing ring gear diameter on the drive shaft. This has the advantage that with a reduction of the number of gears successively from the second end section, one gear after the other from a six gear shift arrangement down to a three gear shift arrangement, different gearbox types can be used with uniform gearwheel pairs without changing the other components. For a six-speed gearbox with an additional reverse gear, accordingly three gear synchronizers acting on both sides are necessary which, as already mentioned above, can firstly serve the first and the reverse gear, secondly a double-acting gear synchronizer can activate the gears 2 and 3 and finally a third double-acting gear synchronizer activates the gears 4 and 5. For the sixth gear at the outermost end of the drive shaft and the output shaft, then as already mentioned above only a gear synchronizer, acting on one side, is necessary for a six-speed gearbox. For this, the gear synchronizers can be arranged both on the drive shaft and also on the output shaft.

In a further embodiment, the drive gearwheel of the third gear is arranged contrary to an increasing alignment of the gears on the drive shaft before the drive gearwheel of the second gear on the drive shaft. For this, for the two-shaft shift gearbox, a rocker switch is provided for the interchanged gears three and two in the rising sequence with a corresponding gear synchronizer acting on both sides. Through the rocker switch, advantageously the interchanged sequence of the gears three and two does not act on the switching position of the shift lever.

The second gear synchronizer, acting on both sides between the driving gearwheel of the second gear and the driving gearwheel of the third gear is preferably arranged on the drive shaft. The third gear synchronizer, acting on both sides between the driving gearwheel of the fourth gear and the driving gearwheel of the fifth gear can likewise be arranged on the drive shaft. Alternatively, however, the second gear synchronizer acting on both sides can be provided between the output gearwheel of the second gear and the output gearwheel of the third gear.

In a further embodiment, the drive shaft and the output shaft for a five-speed gearbox, compared with a six-speed gearbox are shortened by the axial extent of the gear synchronizer, acting on one side, and the axial extent of driving gearwheel and output gearwheel of the sixth gear with otherwise unchanged gearwheel- and shift fork constructions of the synchronous gear and unchanged gear shaft arrangement.

In addition, it is possible for the drive shaft and the output shaft to be retained unshortened, so that for a five-speed gearbox identical drive- and output shafts are used as for a six-speed gearbox. However, in such a five-speed gearbox, the gearwheel pair for the sixth gear and the gear synchronizer, acting on one side, are dispensed with. This has the advantage that the housing construction of the six-speed gearbox including the construction of the bearings of the shafts can be retained.

### BRIEF DESCRIPTION OF THE DRAWINGS

The present invention will hereinafter be described in conjunction with the following drawing figures, wherein like numerals denote like elements, and.

FIG. 1 shows a diagrammatic sketch of a two-shaft shift gearbox according to a first embodiment of the invention;

FIG. 2 shows a diagrammatic sketch of a two-shaft shift gearbox according to a second embodiment of the invention;

FIG. 3 shows a diagrammatic sketch of a two-shaft shift gearbox according to a third embodiment of the invention; and

FIG. 4 shows a diagrammatic sketch of a two-shaft shift gearbox according to a fourth embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

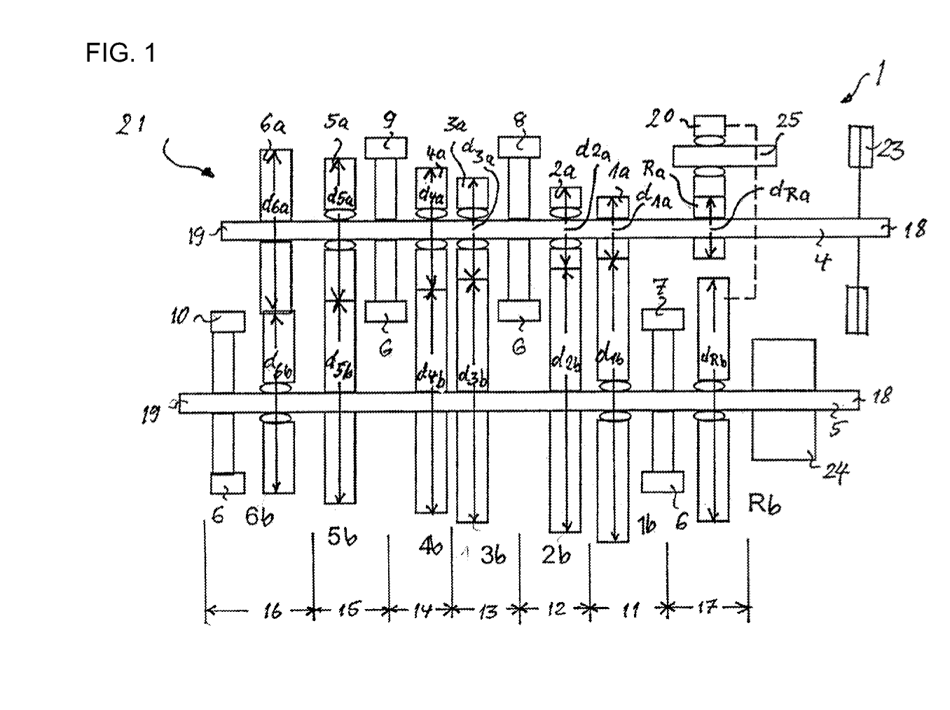

FIG. 1 shows a diagrammatic sketch of a two-shaft shift gearbox 1 according to a first embodiment of the invention. This two-shaft shift gearbox 1 comprises a six gear shift arrangement 21 with the forward gears 11, 12, 13, 14, 15 and 16 and a reverse gear 17. For this, the two-shaft shift gearbox 1 has a drive shaft 4, which is able to be connected via an engine coupling 23 with the engine in a first end section 18 of the drive shaft 4. In this first embodiment of the invention, the diameter of the forward gears 11 to 16 increases from d1a as the smallest diameter of a driving gearwheel over d2a, d3a, d4a, d5a and d6a along the drive shaft 4.

A driving gearwheel Ra of the reverse gear 17 on the first end section 18 of the drive shaft 4 has here almost the same diameter dRa as the driving gearwheel 1a of the first gear 11. For reversal of the rotation direction, the driving gearwheel Ra of the reverse gear does not directly mesh the output gearwheel Rb, rather a rotation direction reversing gearwheel 20 is arranged on a fixedly positioned auxiliary axis 25, which gearwheel meshes with the driving gearwheel Ra and with the output gearwheel Rb of the reverse gear 17.

This six-speed gearbox 21 has four gear synchronizers 7 to 10, wherein the first gear synchronizer 7 is arranged between the output gearwheel Rb of the reverse gear 17 and the output gearwheel 1b of the first gear 11 on the output shaft 5 and consists of a gear synchronizer 7 which is effective on both sides, so that depending on the shift position, either the reverse gear 17 is engaged or the first forward gear 11 is engaged with the gear synchronizer 7 on the output shaft 5.

A second gear synchronizer 8, acting on both sides, is arranged between the second gear 12 and the third gear 13 on the drive shaft 4 and can either be brought into engagement with the drive gearwheel 2a of the second gear 12 or with the drive gearwheel 3a of the third gearwheel 13 via a shift fork by the shift lever. A third gear synchronizer 9, acting in a double-sided manner, is likewise arranged on the drive shaft 4 between the driving gearwheel 4a of the fourth gear 14 and the driving gearwheel 5a of the fifth gear 15 and can be optionally brought into engagement with the driving gearwheel 4a of the fourth gear 14 or with the driving gearwheel 5a of the fifth gear 15.

For coupling the sixth gear 16 with the gearwheel pair 6a and 6b, a gear synchronizer 10, acting on one side, is arranged as switching element 6 on the output shaft 5, which gear synchronizer can bring the output gearwheel 6b of the sixth gear 16, mounted rotatably on the output shaft 5, in engagement with the output shaft 5. Finally, on the first end section 18 of the output shaft 5 an output gearwheel 24 is securely connected with the output shaft 5 and this output gearwheel is mechanically connected with a differential gear. Through the rising arrangement from the first up to the sixth gear it is possible, by shortening the drive shaft 4 and the output shaft 5, to create a five-speed gearbox, a four-speed gearbox or a three-speed gearbox, without carrying out an alteration of the gearwheel pairs, wherein the gear housing of a two-shaft shift gearbox 1 would be shorter with a decreasing gear number. Only in the case of a four-speed gearbox is the third double-acting gear synchronizer 9 replaced by a gear synchronizer 9 acting on one side. All the other gearwheel components and gear synchronizers can be retained unchanged.

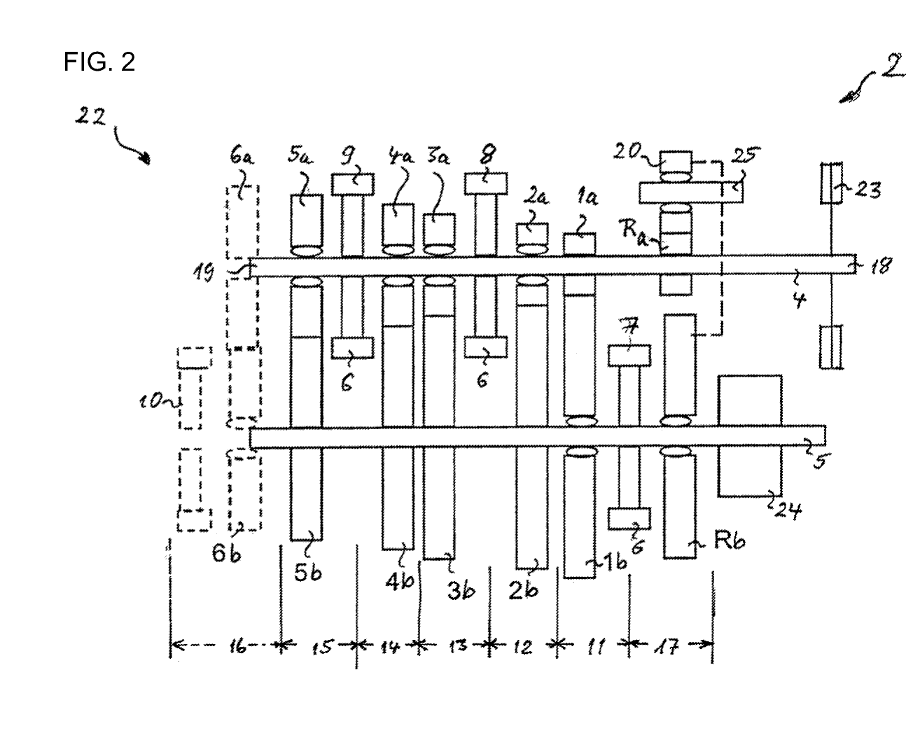

FIG. 2 shows a diagrammatic sketch of a two-shaft shift gearbox 2 according to a second embodiment of the invention. Components having the same functions as in FIG. 1 are designated by the same reference numbers and are not discussed extra in the following figures. The difference of this second embodiment of the invention compared with the first embodiment consists in that by shortening the drive shaft 4 and the output shaft 5, from the six-speed gearbox shown in FIG. 1 a five-speed gearbox 22 can now be produced, wherein the components marked by dashed lines such as the driving gearwheel 6a, the output gearwheel 6b and the gear synchronizer 10, acting on one side, can now be dispensed with.

Thereby, the housing of this five-speed gearbox can be shortened when the drive shaft 4 and output shaft 5 shown in FIG. 2 are shortened accordingly. However, this means at the same time a structural alteration of the bearing of these shafts. When an adaptation of the housing is too cost-intensive, the same housing can be retained with the identical bearing of the drive shaft 4 and output shaft 5, by the shafts also being provided in full length for the five-speed gearbox 22 and only the driving gearwheel 6a, the output gearwheel 6b of the sixth gear 16 and the gear synchronizer 10, acting on one side, being able to be dispensed with.

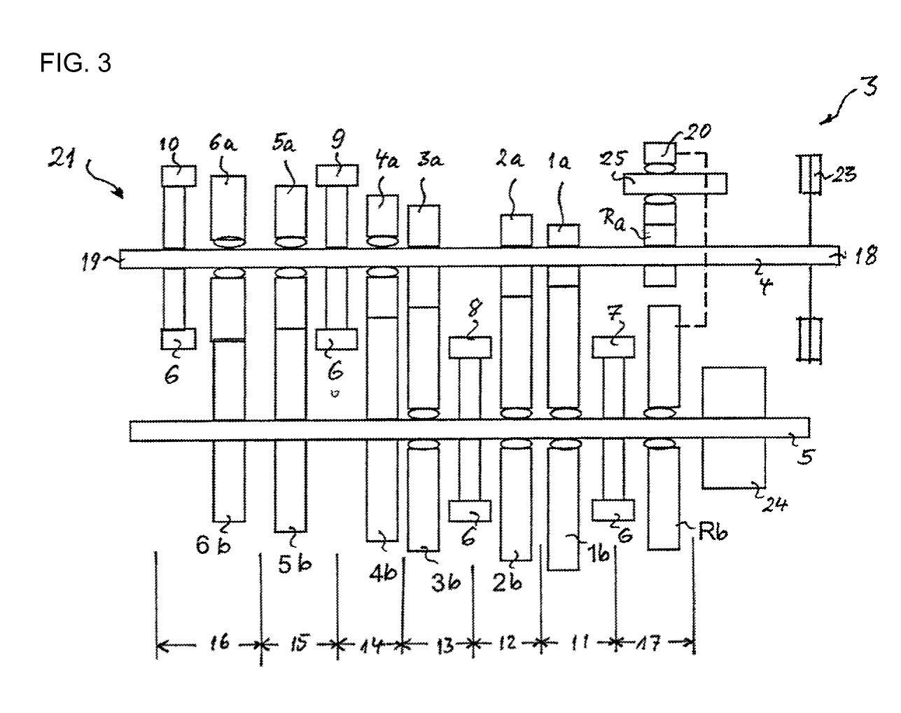

FIG. 3 shows a diagrammatic sketch of a two-shaft shift gearbox 3 according to a third embodiment of the invention. This embodiment of the invention again shows a six-speed gearbox 21 in which, however, the position of the second gear synchronizer 8, acting in a double-sided manner, is altered by the latter being arranged on the output shaft. Thereby, at the same time, an alteration for the output gearwheels is also provided, which are now no longer connected in a rotatably fixed manner with the output shaft as in FIG. 1, but rather are now rotatably mounted with respect to the output shaft, wherein now the driving gearwheels 2a and 3a are fixed in a rotatably fixed manner on the drive shaft.

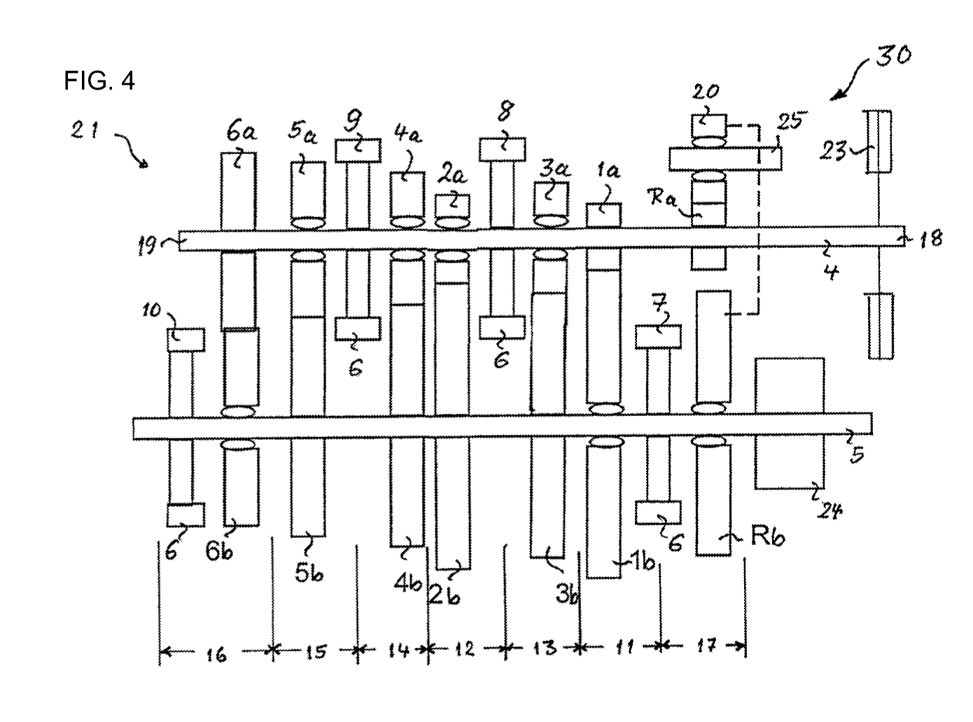

FIG. 4 shows a diagrammatic sketch of a two-shaft shift gearbox 30 according to a fourth embodiment of the invention. The fourth embodiment of the almost corresponds to FIG. 1 with regard to the arrangement of the gear synchronizers, but the sequence of the forward gears is not provided rising continuously with the drive shaft 4 from the first end section 18 to the second end section 19, but rather the second gear 12 and the third gear 13 are interchanged in their sequence, which has no disadvantageous consequences for the basic principle of the two-shaft shift gearbox for all three possible gearbox types, such as the six-speed gearbox 21 shown here or for the five-speed gearbox shown in FIG. 2 or for a four-speed gearbox down to a three-speed gearbox. A rocker switch, which is not shown here, only has to be provided, in order to retain the shift lever positions in a known manner, despite an exchange of the sequence of the second gear 12 with that of the third gear 13.

Likewise, the gears 14 and 15 or respectively 11 and 17 can be interchanged. In principle also the groups 11/17, 14/15 and 12/13 can be interchanged with each other. The gear synchronizers 8, 9 and 10 can be arranged both on the drive shaft 4 and also on the output shaft 5. By introducing corresponding rocker switches, nevertheless in most cases a standard H-shift arrangement can be retained on the gear selector lever in the vehicle interior compartment.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A two-shaft shift gearbox of a motor vehicle, comprising:
a drive shaft;
an output shaft;
driving gearwheels arranged on the drive shaft;
output gearwheels arranged on the output shaft; and
switching elements adapted to bring the driving gearwheels in pairs into engagement with the output gearwheels via gear synchronizers,
wherein a lowest driving gearwheel of a lowest gear with a smallest ring gear diameter is arranged on a first end section and a highest driving gearwheel of a highest gear with a largest ring gear diameter is arranged on a second end section of the drive shaft lying opposite the first end section.

2. The two-shaft shift gearbox according to claim 1, wherein a first gear synchronizer of the gear synchronizers is adapted to act on one side for a sixth gear arranged on the second end section on at least one of the drive shaft or the output shaft.

3. The two-shaft shift gearbox according to claim 1,
wherein in a region of the first end section of the drive shaft a rotation direction reversing gearwheel is arranged on an auxiliary axis,
wherein the rotation direction reversing gearwheel is adapted to mesh at a substantially same time with a driving gearwheel and an output gearwheel for a reverse gear, and
wherein a first gear synchronizer of the gear synchronizers acting on both sides is arranged on the output shaft between the output gearwheel of the reverse gear and the output gearwheel of a first gear.

4. The two-shaft shift gearbox according to claim 1, wherein the driving gearwheels are arranged in succession with increasing gear number in a rising sequence from the first end section to the second end section with an increasing ring gear diameter on the drive shaft.

5. Two-shaft shift gearbox according to claim 1,
wherein a driving gearwheel of a third gear is arranged contrary to an increasing alignment of gears on the drive shaft in front of the driving gearwheel of a second gear on the drive shaft, and
wherein the two-shaft shift gearbox comprises a rocker switch adapted for a three interchanged gear and two interchanged gear in a rising sequence cooperates with a corresponding gear synchronizer acting on both sides.

6. The two-shaft shift gearbox according to claim 1, wherein a second gear synchronizer acting on both sides is arranged between a driving gearwheel of a second gear and the driving gearwheel of a third gear.

7. The two-shaft shift gearbox according to claim 1, wherein a third gear synchronizer acting on both sides is arranged between a driving gearwheel of a fourth gear and the driving gearwheel of a fifth gear.

8. The two-shaft shift gearbox according to claim 6, wherein the second gear synchronizer acting on both sides is arranged between an output gearwheel of the second gear and the output gearwheel of the third gear.

9. The two-shaft shift gearbox according to claim 2, wherein a gear synchronizer acting on the one side is arranged on the output shaft and brings an output gearwheel of the sixth gear in engagement with a driving gearwheel of the sixth gear.

10. The two-shaft shift gearbox according to claim 9, wherein the gear synchronizer acting on the one side is arranged on the drive shaft and brings the driving gearwheel of the sixth gear in engagement with the output gearwheel of the sixth gear.

11. The two-shaft shift gearbox according to claim 9, wherein the drive shaft and the output shaft for a five-speed gearbox, compared with a six-speed gearbox are shortened by an axial extent of the gear synchronizer, acting on the one side, and by the axial extent of the driving gearwheel and the output gearwheel of the sixth gear with an otherwise unchanged gearwheel and shift fork construction of a synchronous gear and with an unchanged gear shaft arrangement.

12. The two-shaft shift gearbox according to claim 2,
wherein the drive shaft and the output shaft for a six-speed gearbox and for a five-speed gearbox are substantially the same, and
wherein a gearwheel pair for the sixth gear and a gear synchronizer acting on the one side are not provided on shafts of the five-speed gearbox.
